(19) United States
(12) Patent Application Publication
(10) Pub. No.: US 2014/0334007 A1
(43) Pub. Date: Nov. 13, 2014

(54) Optical Element Stacks for the Direction of Light

(71) Applicant: The Regents of the University of California, Oalkand, CA (US)

(72) Inventor: Benjamin Monreal, Santa Barbara, CA (US)

(21) Appl. No.: 14/270,956

(22) Filed: May 6, 2014

Related U.S. Application Data
(60) Provisional application No. 61/820,304, filed on May 7, 2013.
(60) Provisional application No. 61/859,640, filed on Jul. 29, 2013.

(51) Int. Cl. G02B 19/00; G02B 5/09; F21S 11/00; G02B 26/08

(52) U.S. Cl. CPC G02B 19/0028; G02B 26/0816; G02B 26/0883; G02B 5/09; F21S 11/002; G02B 19/0042
USPC 359/592; 359/831; 359/853

(57) ABSTRACT

Provided herein are devices and associated methods for the direction of light, e.g. sunlight. The devices may comprise various stacked optical elements, including wedge prisms and angled-facet minors, such as Fresnel prisms and mirrors. These may be rotated to effect various angles of light redirection. In one embodiment, the invention comprises directional reflectors which enable incident light to be reflected to a target of fixed location. In one embodiment, the target of the directional reflector is a solar energy target such as a thermal solar receiver or photovoltaic element. In another embodiment, the invention comprises directional beam guides which can redirect incident light arriving at a range of angles to a target. In one embodiment the target of the directional beam guide is the interior of a building, wherein directional beam guides are mounted in or on a window to effect light transmission to the target within the building.

### CROSS-REFERENCE TO RELATED APPLICATIONS

This application is based on and claims the benefit of priority of United States Provisional Patent Application Ser. No. 61/820,304 filed on May 7, 2013 and U.S. Provisional Patent Application Ser. No. 61/859,640, filed on Jul. 29, 2013, the contents of both of which are hereby incorporated by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

Sunlight is captured in many applications, including solar power generation, heating, lighting, and other uses. Because the sun constantly moves throughout the day, the angle of solar incidence is ever-changing and a means of keeping incident light focused on a solar target is required for maximum performance. Accordingly, there is a need in the art for devices and methods that allow for the efficient guiding of sunlight to targets throughout the day.

### SUMMARY OF THE INVENTION

Disclosed herein are novel devices and methods which allow for the substantial redirection of incident sunlight and which keep the redirected sunlight aimed at a target. The simple design of these novel devices and associated methods allows for efficient redirection of natural sunlight to solar panels, thermal solar energy collectors, building interiors, and other targets of light or solar energy. The devices of the invention comprise stacks of deflecting prisms and, in some embodiments, deflecting mirrors. By altering the configuration or orientation of one or more of the optical elements in the stack, incident light can be redirected or reflected at a desired angle in order to hit a target.

### BRIEF DESCRIPTION OF THE DRAWINGS

FIG. 1 depicts a pair of circular optical elements (101 and 102) comprising Fresnel elements. The Fresnel elements comprise multiple parallel facets (103), which are separated by grooves (104).

FIG. 2 depicts side profile views (2A and 2B) of a Fresnel element. A front view of the Fresnel element is depicted in FIG. 2C.

FIG. 3 depicts a directional reflector comprising a Fresnel prism and Fresnel mirror.

FIG. 4 depicts a directional beam guide comprising two stacked Fresnel prisms.

FIG. 5 depicts a cutaway of one floor of a building utilizing directional beam guides for interior lighting.

### DETAILED DESCRIPTION OF THE INVENTION

The invention comprises the use of stacked optical elements comprising deflecting prisms and deflecting minors. The various embodiments of the invention allow for the redirection of incident light at almost any desired angle.

An “optical element,” as used herein, will refer to a body such as a deflecting prism, a deflecting mirror, or a focusing lens, the function of such body being to bend, deflect, reflect, or focus light.

As used herein, a deflecting prism is a transmissible body wherein light passing through the body is deflected at a predictable angle based on the orientation, configuration, and optical properties of the body.

As used herein, a deflecting minor is a reflective body wherein light striking the body is reflected at a predictable angle based on the orientation, configuration, and optical properties of the body.

As used herein, “Fresnel prism” will refer to a substantially flat piece of transmissible material, having on one, or in some cases both, surfaces a series of angled facets. A Fresnel prism can be described as a series of prisms lined up base to apex on a planar surface, for example as depicted in FIGS. 2A and 2B. Each Fresnel prism comprises a series of planar facets (201) which are angled from the plane of the surface at angle f (202 and 203), referred to as the “facet angle.” Note that the facet angles in FIGS. 2A and 2B are identical, and the light deflection effected by each of the two mirror-image elements will be identical. Viewing the face of the facets (FIG. 2C), the borders between each facet will be referred to as grooves (204).

Light incident upon a Fresnel prism will be deflected at a predictable angle, such angle being dependent upon the angle of such incident light, the facet angle of the facet, and the refractive index of the prism material. Such relationships are known in the field of optics and may be predicted by one of skill in the art using standard optics equations.

As used herein, “Fresnel mirror” will refer to a substantially flat piece of material, having one reflective surface comprising a series of angled facets. A Fresnel mirror can be described as a series of parallel angled minors on a planar surface. Light incident upon a Fresnel mirror will be deflected at a predictable angle, such angle being dependent upon the angle of such incident light (relative to the facet) and the facet angle of the mirror facet. Such relationships are known in the field of optics and may be predicted by one of skill in the art using standard optics equations.

As used herein, “outer” will refer to an element within an optical element stack which first receives incident light. Correspondingly, “inner” will refer to an element behind the outer element, onto which light is passed from the outer element. For an optical element stack oriented horizontally to the axis of gravity, i.e. flat on the ground, the outer element will be the top element and the lower element will be the inner element. For a vertically oriented optical element stack attached to a window, the outer element will be that which is oriented towards the outside of the building while the inner element would be disposed towards the interior of the building.

As used herein, “solar” or “target” will refer to an object at or onto which light is guided by the optical element stacks of the invention. Exemplary targets include solar panels, thermal solar heat storage means, building interiors, reflectors, diffusion panels, etc. Typically, the target is of a fixed location, but moving targets may be used as well where the location of the target is known. The target may be a fixed point, or the target may be a defined area, the use of a wider target area enabling light to be redirected to it for a longer portion of the day.

As used herein, “incident light” will refer to light impinging upon the outer surface of an optical element stack. In many cases, the incident light will be sunlight, and references to the sun as the source of light will be used for convenience. However, it will be understood by one of skill in the art that the incident light may be from any source and that the devices and methods of the invention may be used to redirect artificial light sources or natural light sources besides direct sunlight.

As used herein, “exit angle” refers to the angle at which light exits a Directional Reflector or a Directional Beam Guide.

The embodiments of the invention include two major classes of devices: Directional Reflectors and Directional Beam Guides. These devices consist of stacked optical elements comprising various combinations of deflecting prisms and, in some embodiments, deflecting mirrors.

A deflecting prism is any prism which can alter the path of incident light passing through it. Exemplary deflecting prisms include wedge prisms, Fresnel prisms, Amici roof prisms, Risley prisms, pentaprisms, Porro prisms, and other prisms known in the art.

For convenience, the deflecting prism will be referred to as a single unit. However, it will be understood that this single functional unit may comprise an array of many prisms, for example, a plurality of prisms which are grouped substantially along a single plane. Prism arrays may be homogeneous, comprising a single prism type, or may be heterogeneous, comprising more than one type of prism.

A deflecting mirror is a body with a highly reflective coating and a shape which causes the body to reflect incoming light at a predictable angle based upon the alignment and configuration of the minor. Exemplary deflecting mirrors include plane mirrors, Fresnel mirrors, convex, or concave mirrors. The degree of deflection can be predicted based on the configuration and/or orientation of the deflecting minor. In some embodiments, the configuration and/or orientation of the deflecting mirror is controllable.

For convenience, the deflecting mirror will be referred to as a single unit. However, it will be understood that this single functional unit may comprise an array of many minors, for example, a plurality of mirrors which are grouped substantially along a single plane. Minor arrays may be homogeneous, comprising a single mirror type, or may be heterogeneous, comprising more than one type of mirror.

The prisms and mirrors of the invention may be made of any suitable material, as known in the art. Glass, polycarbonate, resin, or other transmissible or substantially transparent materials may be utilized for prisms. Reflective coatings known in the art, such as silver, gold, or aluminum and alloys thereof, may be used in the mirrors of the invention. Prisms and mirrors may be fabricated by any means known in the art, for example by milling, grinding, stamping, molding, etc. In one embodiment, the optical elements of the invention comprise stamped thin films.

Directional Reflectors

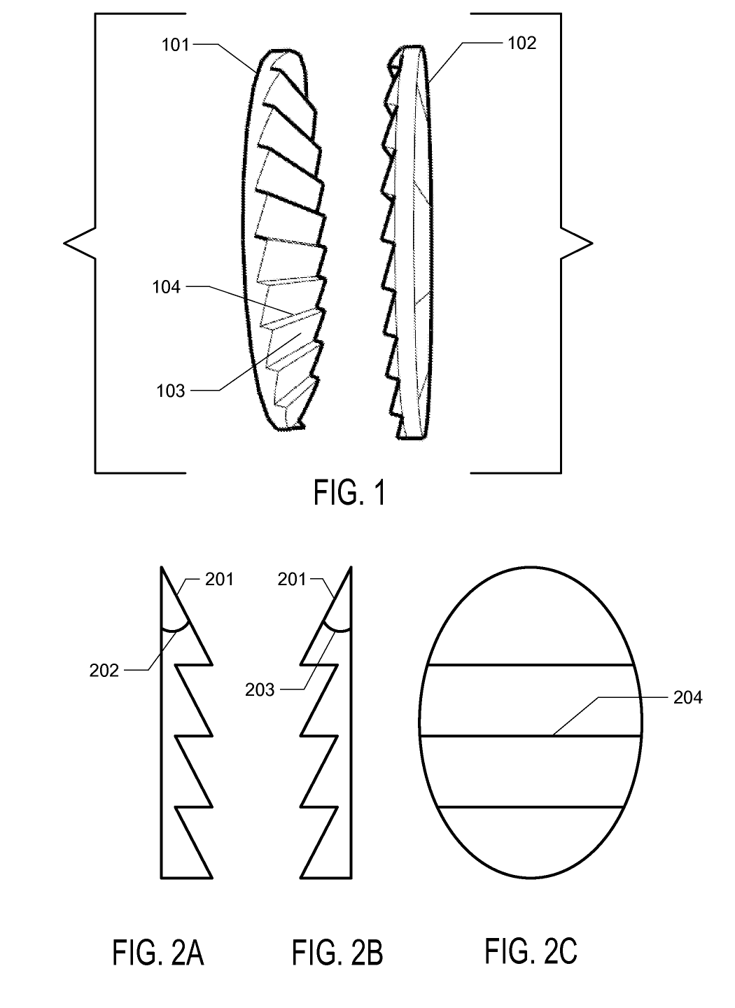

A Directional Reflector can be used to reflect incident light (e.g. sunlight) at a desired angle. Directional Reflectors comprise an outer deflecting prism and an inner deflecting mirror. These two optical elements are stacked such that incoming light: (1) is deflected by the deflecting prism as it enters the device; (2) then hits and is reflected back by the deflecting mirror, which may further deflect the light; and (3) is deflected again as it passes back through the deflecting prism to the outside. By changing the orientation or configuration of each the deflecting prism and/or deflecting minor, the degree of deflection can be controlled and a very significant range of exit angles may be effected. The stacked Fresnel optical elements depicted in FIG. 1 represent an exemplary configuration for a directional reflector wherein, assuming a light source shining from left to right, the outer element is a deflecting wedge prism (101) and the inner element is a deflecting minor (102), and in which the exit angles may be modified in a predictable manner by simple rotations of the elements.

Directional Beam Guides

Directional Beam Guides comprise two stacked deflecting prisms. This apparatus allows incident light passing through the device to be redirected, or “guided” in a desired direction. The two deflecting prisms are stacked such that incoming light: (1) is deflected by the outer deflecting prism as it enters the device; and then (2) passes through the second, inner deflecting prism, which may further deflect the light. By changing the configuration and/or orientation of the deflecting prisms, the degree of deflection can be controlled and a very significant range of exit angles may be effected. The stacked Fresnel optical elements depicted in FIG. 1 can represent an exemplary configuration for a Directional Beam Guide wherein, assuming a light source shining from left to right, the both the outer element (101) and the inner element (102) are deflecting wedge prisms, and in which the exit angles may be modified in a predictable manner by simple rotations of the two elements.

Directional beam guides used as solar energy concentrators are known in the art. For example, a directional beam guide for concentration of solar energy is described in United States Patent Application Publication Number 2010/0224231, entitled “Photovoltaic module featuring beam steering and fixed concentrator,” by Hoke. The present invention provides the art with novel uses and applications for Directional Beam Guides.

Configuration of the Devices.

For both the Directional Beam Guide and the Directional Reflector, light may be guided with great precision. In the Directional Beam Guide, light passes through the outer prism, traverses the space between the outer prism and bottom prism, and then passes through the inner prism and out into the next medium (typically air). In the Directional Reflector, light passes through the outer prism, traverses the space between the outer prism and underlying deflecting mirror, and then is reflected back through the top prism and out into the original medium (typically, air). For each of these devices: the index of refraction is known; the index of refraction of the medium between the components and outside the device is known; and the predicted degree of deflection by prism and mirror elements is known based on the shape, configuration, and/or the orientation of the prism or mirror. Accordingly, using standard optical equations, the degree of deflection at each stage of the light's passage from entering to exiting the device can be predicted. Because the elements can, in some embodiments, rotate or otherwise change orientation or configuration, the device can be adjusted to emit light at any desired exit angle, within the limits of the prisms' and minors' combined deflection abilities at a given angle of incident light.

For convenience, the embodiments of the invention have been described as encompassing two stacked optical elements. However, it is understood that the scope of the invention encompasses stacks comprising three or more elements. For example, a Directional Reflector may comprise two deflecting prisms stacked above a deflecting mirror. A Directional Beam Guide may comprise three deflecting prisms. Such systems are more complex and expensive than double layer stacks, and may have much lower efficiency due to internal losses from reflection, absorbance, etc. However, such systems can advantageously expand the range of angles at which incident light can be reflected or directed.

It will be understood that additional optical elements may be positioned above, between, or below the stacked optical elements of the invention. For example, filters, focusing lenses, beam splitters, and other optical components known in the art may be used to enhance or extend the basic capabilities of the devices. In one embodiment, a transparent cover is placed over the device to protect the optical elements and associated controls and motors from the elements.

The distance between the optical elements may vary. Distances of millimeters to several centimeters are preferred for efficiently directing the majority of the light from the outer optical element to the inner optical element, however larger distances may be used (e.g. meters). In some embodiments, the inner optical element is larger than the outer optical element in order to capture laterally deflected light from the outer optical element.

Certain inefficiencies may be inherent in the optical element stacks of the invention, for example due to reflection, absorbance, and scattering. The use of anti-reflective coatings, as known in the art, is desirable to reduce undesired reflections. In another implementation, the use of liquids between the optical elements is contemplated, the liquids having an index of refraction matched to that of the optical elements, in order to minimize refraction artifacts and inefficiencies created by the intervening layer of air between the optical elements. Likewise, index of refraction matching coatings or surface treatments, as known in the art, may used to minimize refraction artifacts.

Controlling Exit Angle.

In a preferred implementation, one or both of the optical stacked elements of the Directional Beam Guide or the Directional Reflector can rotate or otherwise change orientation or configuration to effect different angles of deflection for a given angle of incident light. Allowing both elements to controllably rotate or otherwise change angle of deflection maximizes the degree of control over the angle of the exit beam, allowing the stacked devices of the invention to direct light to a fixed target even as the angle of incident light changes dramatically throughout the day. A wide range of exit angles is accessible purely via the rotation of one or both of the stacked elements within the plane of the stack. Other orientation and configuration changes may grant access to additional range of exit angles.

The Directional Reflectors and Directional Beam Guides of the invention may be arranged in any number of configurations. In a preferred configuration, the elements are circular (or are mounted within circular bodies) and are capable of being rotated relative to one another in an arc or full circle by the action of miniature motors. The motors may be controlled by a controller means. The controller means may comprise software which rotates the elements as necessary to effect the desired exit angle. The location of the stacked optical element in relation to its target is input into or is detected by the controller. This establishes a desired exit angle for light exiting the device. The role of the controller is to orient/configure the optical elements to maintain, for as long as possible throughout the day, the desired exit angle for reflected or redirected light. At any specific point on the earth, the angle of incident solar light can be predicted for any given time of day on any specific day of the year. Thus, the controller can position/configure optical elements of the Directional Reflectors or Directional Beam Guides to effect at the desired exit angle (within the deflection limits of the optical elements), based on the current day of the year, the time of day, latitude, and taking into account the compass angle and angle of tilt (relative to horizontal or vertical) at which the stacked device is oriented. The invention comprises computer programs which control the rotation of the stacked elements to effect specific exit angles based upon the known angle of solar incidence at any time and location. Alternatively, the angle of solar incidence can be detected in real time by a light sensing means, and via the controller, motors may be actuated to orient the optical elements to respond to solar incidence angle for deriving optimal exit angle.

The optical element stacks of the invention can mounted in a fixed orientation, for example flat on the ground, on sloped ground, or on a flat or sloped roof. Although the devices of the invention may effect a wide range of exit angles, the deflection limits of the optical elements constrain the maximum range of output angle. However, if the entire stacked devices themselves can also be moved, their ability to direct light to a target is enabled for a wider range of incident light angles. Accordingly, the optical element stacks of the invention may be affixed to mountings that tilt, for example on panels that can be tilted or rotated by motors to track the sun. Orientation of the device can be adjusted continuously, or may be tuned at longer (e.g. seasonal) time scales.

Wedge and Fresnel Devices.

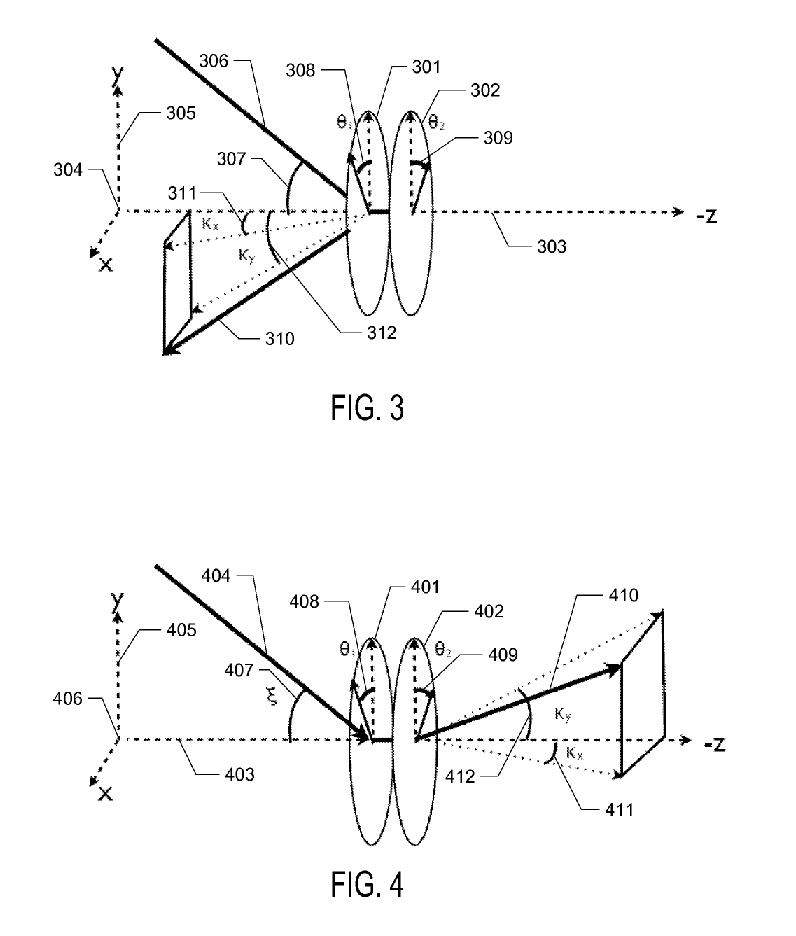

In a preferred implementation of the invention, the optical elements of the devices comprise wedge prisms such as Fresnel prisms and minors with angled facets such as Fresnel mirrors. Wedge elements such as Fresnel elements may comprise facet angles of that range from near 0 degrees (horizontal) to 90 degrees (vertical). A preferred range of facet angle is application-dependent. Many applications favor wedge prisms with angles between 20 and 50 degrees, for example in the range of 30-40 degrees, or mirror angles between 5 and 20 degrees. Advantageously, simple rotation of wedge elements (for example, rotation around a Z axis, as depicted in FIGS. 3 and 4), allows for substantial, predictable redirection of transmitted light (prism) or reflected light (mirror) with minimal adjustments of the elements of the device.

In one embodiment, the Directional Reflector comprises an outer wedge prism such as a Fresnel prism and an inner angled-facet minor such as a Fresnel minor. The angle of the exiting light is predictable, based on the angle of the incident light, the facet angle of the Fresnel prism, the refractive index of the Fresnel prism material, the angle at which the light bent by the Fresnel prism strikes the Fresnel minor, the facet angle of the Fresnel mirror, and the angle at which the reflected light is incident upon the upper Fresnel prism. Other factors, such as the reflective index of the Fresnel prism material, the Fresnel minor surface, and the composition of the medium separating the Fresnel prism from the Fresnel minor (for example, air) will also affect the angle at which the incident light is reflected, in a predictable manner based on the known index of refraction of such materials and its known reflective properties.

An exemplary Directional Reflector comprising a Fresnel wedge prism and Fresnel mirror is depicted in FIG. 3. An outer deflecting prism (301) is paired with an inner directional minor (302). A z axis (303) runs perpendicular to the paired optical elements. The Z axis defines an x axis (304) and y axis (305) coordinate system. For incident light (306) striking the outer Fresnel prism, a coordinate system is defined such that the angle of incident light, (307), is defined by the angle of the light between the y and z axes (with no x axis component). θ₁ (308) is the angle of rotation of the outer Fresnel prism and θ₂ (309) defines the angle of rotation of inner Fresnel mirror, wherein when θ₁ or θ₂ equals zero, the grooves (for example illustrated as 105 in FIG. 1 or 204 of FIG. 2C) of that Fresnel element are oriented parallel to the x axis. The facets of the Fresnel prism may face +z or −z. The facets of the Fresnel mirror face +Z. For any given θ₁ and θ₂, and depending on the facet angles of the optical elements (for example, illustrated as 202 and 203 in FIGS. 2A and 2B), light will be reflected back out of the directional reflector on a vector (310) defined by the angle Kₓ (311) between the x axis and the z axis and the angle K_{y} (312) between the y axis and the z axis.

The exit angle of light from the Directional Reflector may be calculated for any angle of incident light using standard optics equations. For example, Kₓ may be determined by Equation 1 and K_{y} may be determined by Equation 2.

$$\begin{matrix}{κ}_{x} = {sin}^{- 1} ( \frac{{n}_{2}}{{n}_{1}} sin ( {sin}^{- 1} ( \frac{{n}_{1}}{{n}_{2}} sin ( {f}_{2} sin ( {θ}_{2} ) ) ) + 2 {f}_{1} sin ( {θ}_{1} ) - 2 {f}_{2} sin ( {θ}_{2} ) ) ) - {f}_{2} sin ( {θ}_{2} ) . & Equation 1 \\ {κ}_{y} = {sin}^{- 1} ( \frac{{n}_{2}}{{n}_{1}} sin ( {sin}^{- 1} ( \frac{{n}_{1}}{{n}_{2}} sin ( ξ - {f}_{2} cos ( {θ}_{2} ) ) ) - 2 {f}_{1} cos ( {θ}_{1} ) + 2 {f}_{2} cos ( {θ}_{2} ) ) ) - {f}_{2} cos ( {θ}_{2} ) . & Equation 2\end{matrix}$$

wherein f is the facet angle, n1 is the refractive index of the medium in which light is travelling (typically air), n2 is the refractive index of the material from which the Fresnel lens is made, θ₁ is the angle of rotation of the Fresnel prism, θ₂ is the angle of rotation of the Fresnel minor, ξ is the angle of incident light (defined by the angle of the light between the y and z axes, with no x axis component), Kₓ is the exit angle on the x-z plane and K_{y} is the exit angle on the y-z plane. The equations may be used with units of radians or degrees.

The Directional Beam Guide may be configured as two stacked Fresnel prisms, both of which are mounted in an apparatus which allows controlled, independent 360° rotation of each prism. An exemplary Directional Beam Guide comprising two stacked Fresnel prisms is depicted in FIG. 3.

An exemplary Directional Beam Guide comprising two stacked Fresnel wedge prisms is depicted in FIG. 4. An outer Fresnel prism (401) is paired with an inner Fresnel prism (402). A z axis (403) runs perpendicular to the paired optical elements. The Z axis defines an x axis (404) and y axis (405) coordinate system. For any incident light (406) striking the outer Fresnel prism, a coordinate system is defined such that the angle of incident light, ε (407), is defined by the angle of the light between the y and z axes (with no x axis component). θ₁ (408) is the angle of rotation of the outer Fresnel prism and θ₂ (409) defines the angle of rotation of inner Fresnel prism, wherein when θ₁ or θ₂ equals zero, the grooves (for example illustrated as 105 in FIG. 1 or 204 in FIG. 2C) of that Fresnel element are oriented parallel to the x axis. The facets of the Fresnel prisms may face +z or −z. For any given θ₁ and θ₂, and depending on the facet angles of the optical elements (for example, illustrated as 202 and 203 in FIGS. 2A and 2B), light will exit the directional beam guide on a vector (410) defined by the angle Kₓ (411) between the x axis and the z axis and the angle K_{y} (412) between the y axis and the z axis.

The exit angle of light from the Directional Beam Guide may be calculated for any angle of incident light using standard optics equations. For example, Kₓ may be determined by Equation 3 and K_{y} may be determined by Equation 4

$$\begin{matrix}{κ}_{x} = - {sin}^{- 1} ( \frac{{n}_{2}}{{n}_{1}} sin ( {sin}^{- 1} ( \frac{{n}_{1}}{{n}_{2}} sin ( {f}_{2} sin ( {θ}_{2} ) ) ) + {f}_{1} sin ( {θ}_{1} ) - {f}_{2} sin ( {θ}_{2} ) ) ) + {f}_{1} sin ( {θ}_{1} ) . & Equation 3 \\ {κ}_{y} = {sin}^{- 1} ( \frac{{n}_{2}}{{n}_{1}} sin ( {sin}^{- 1} ( \frac{{n}_{1}}{{n}_{2}} sin ( ξ - {f}_{2} cos ( {θ}_{2} ) ) ) - {f}_{1} cos ( {θ}_{1} ) + {f}_{2} cos ( {θ}_{2} ) ) ) + {f}_{1} cos ( {θ}_{1} ) . & Equation 4\end{matrix}$$

wherein f is the facet angle, n1 is the refractive index of the medium in which light is travelling (typically air), n2 is the refractive index of the material from which the Fresnel lens is made, θ₁ is the angle of rotation of the top Fresnel prism, θ₂ is the angle of rotation of the bottom Fresnel mirror, ε is the angle of incident light (defined by the angle of the light between the y and z axes, with no x axis component), Kₓ is the exit angle on the x-z plane and K_{y} is the exit angle on the y-z plane. The equations may be used with units of radians or degrees.

Heliostats for Concentrating Solar Energy.

In one embodiment, the Directional Reflectors of the invention may be utilized as heliostats for concentrating solar energy on a target area, for example such as the central tower in a thermal solar power generator or a photovoltaic panel, e.g. a panel configured for conversion of concentrated light to electricity. For example, an array of flat Directional Reflector heliostats may be used. The advantages of such a system over a conventional heliostat array includes a lower physical profile (and thus reduced wind load) and lower weight, and consequently much less support structure is required. Modular heliostat arrays may be easily placed on ground or roofs, requiring less expensive and complex installation. Additionally, the motors required to rotate the Fresnel prism and Fresnel mirror elements need only overcome the friction of rotation, and thus smaller, cheaper motors may be used. An exemplary array of Directional Reflectors as heliostats are depicted in FIG. 6. In such a configuration, the heliostat comprises a Directional Reflector, a controller, an actuating motor, and a target. Optionally, the optical elements of the invention are covered by a transparent or highly transmissive cover which protects the optical elements and actuating motors from the elements and facilitates easy cleaning of dust or other debris from the heliostat.

Interior Lighting.

In one embodiment, the invention comprises an interior lighting beam guide, which comprises a Directional Beam Guide, a controller, and an actuating means (e.g. motors). The interior lighting beam guide will direct incident light that strikes the surface of a building (e.g. a vertical surface) into the interior of the building. For example, a vertically oriented lighting beam guide mounted in a wall, or on a window pane, can direct sunlight incident upon the surface of the building into the interior of the building for much of the day. The target for each interior lighting beam guide may comprise a diffusion screen which spreads light within a target area such as a room. An array of interior lighting beam guides may be used to illuminate multiple targets for creating consistent light throughout the interior of the building. For example, a long row of interior lighting beam guides along the face of a building may be used.

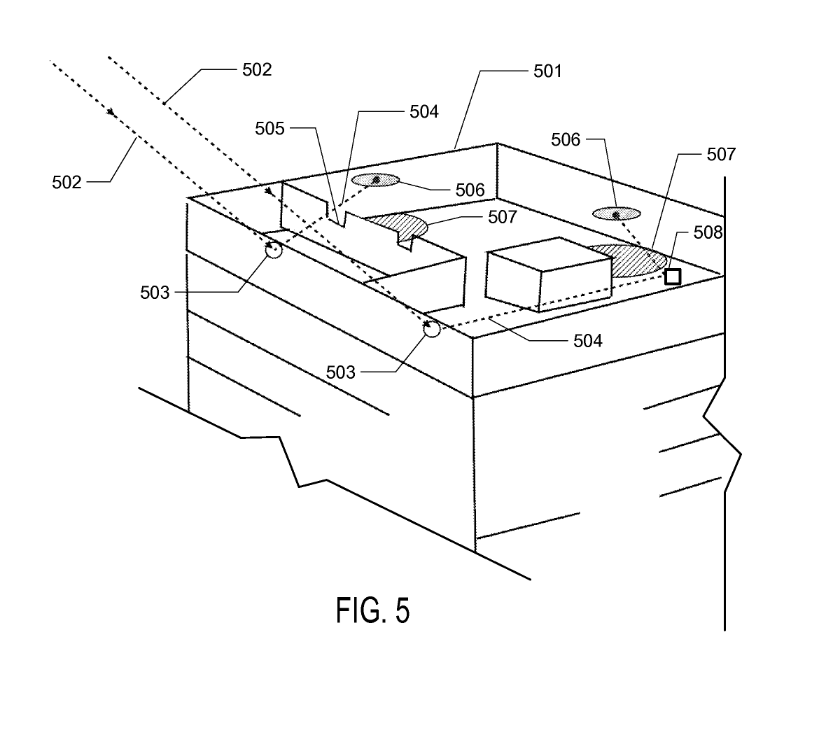

FIG. 5 depicts a cutaway of one floor of a building (501) utilizing directional beam guides for interior lighting. Sunlight (502) hits a series of directional beam guides (503) mounted vertically in a window. By the action of the controller, which may be programmed with the orientation of the lighting beam guide (e.g. the direction the wall of the building is facing), the location of the building (e.g. latitude, as input or determined by a geolocation means) and the exit angle required to hit the target, the orientation of the optical elements in the directional beam guide are adjusted throughout the day to keep redirected sunlight (504) substantially aimed at a target. The target may be a fixed point in the interior of the building, or the target may be a defined area, the use of a wider target area enabling light to be redirected to it for a longer portion of the day. The target may comprise a wall or a diffusion screen (506) to scatter, soften, or distribute the light around a target area (507). Advantageously, the use of cutaways or windows (505) in interior walls, preferably at ceiling level, creates passages for redirected sunlight to pass through walls and reach deep into the interior of the building, wherein a diffusion screen may be placed to scatter the light over a target area (507). Alternatively, the target may comprise a reflector (508), for example a mirror or highly reflective surface, or series of reflectors, which direct the light to a final target, such as diffusion screen (507). Advantageously, reflectors or a series of reflectors can be used to direct light around corners and can bypass obstructions such as walls, elevators shafts, or stairwells.

The interior lighting beam guides of the invention may be mounted on the interior side of a window pane, preferably at or near ceiling level in order to avoid obstructing the view out the window. In one embodiment, the interior lighting beam guides are built into the wall, minimizing profiles and improving aesthetics. In an alternative embodiment, the interior lighting beam guides comprise units which can be individually mounted onto an existing window pane (for example by use of suction cups or adhesives) or hung from a ceiling in front of the window, allowing retrofitting of extant building with the interior lighting systems of the invention. In one embodiment, the window pane exterior to the interior lighting beam guide is coated with an infrared filtering coating which prevents the redirection of heat into the building while preserving the passage of visible light. In another embodiment, an infrared filtering insert can be reversibly placed in front of the interior lighting beam guide to control infrared passage, allowing seasonal adjustment of co-transmitted heat into the interior.

In some embodiments, the interior lighting beam guides are mounted vertically. In other embodiments, the interior beam guides are mounted at an angle to maximize harvest of incident light. In some embodiments, the interior lighting beam guides are mounted substantially horizontally, for example, as a skylight on the roof of a building, to direct light essentially downward into the interior. In another embodiment, the target of the interior lighting beam guide is a light steering element such as a light tube, fiber optic filaments, or other light guides.

The disclosed embodiments are presented for purposes of illustration and not limitation. While the invention has been described with reference to the described embodiments thereof, it will be appreciated by those of skill in the art that modifications can be made to the structure and elements of the invention without departing from the spirit and scope of the invention as a whole.

1. A directional reflector, comprising
an outer deflecting prism and
an inner deflecting minor.

2. The directional reflector of claim 1, wherein
the orientation or configuration of the deflecting prism and/or the orientation or configuration deflecting minor
may be adjusted such that light incident upon the directional reflector at a given angle of incidence is reflected at a desired exit angle.

3. The directional reflector of claim 2, wherein
the deflecting prism is a Fresnel prism and the deflecting mirror is a Fresnel mirror, and the exit angle is controlled by rotating the Fresnel elements to effect the desired exit angle.

4. The directional reflector of claim 3, wherein
the angle of rotation of each element is controlled by an actuating motor under the control of a computerized controller.

5. A heliostat, comprising
one or more directional reflectors wherein incident light is reflected onto a target.

6. The heliostat of claim 5, wherein
each directional reflector comprises a Fresnel prism and a Fresnel mirror,
the rotation of each element being effected by an actuating motor under the control of a computerized controller.

7. The heliostat of claim 5, wherein
the target comprises a thermal solar energy collector or a photovoltaic panel.

8. A method of directing sunlight to a target located in the interior of a building, comprising
mounting a directional beam guide on or behind a vertically-oriented window of the building, and
controlling the exit angle of light incident upon the directional beam guide such that it is directed to the target.

9. The method of claim 8, wherein
the directional beam guide comprises two stacked Fresnel prisms.

10. The method of claim 8, wherein
the target is a diffusion screen.

11. The method of claim 8, wherein
the directed light passes through windows or cutouts in interior walls within the building.

12. The method of claim 8, wherein
the target is a reflector.

13. The method of claim 8, wherein
the directional reflector is mounted vertically.

14. The method of claim 13, wherein
the directional reflector is built into the wall.

15. The method of claim 13, wherein
the directional reflector is mounted on a window pane.
